(19) United States
(12) Patent Application Publication
(10) Pub. No.: US 2024/0049761 A1
(43) Pub. Date: Feb. 15, 2024

(54) PREBIOTIC COMPOSITION OF PECTINOLIGOSACCHARIDES (POS)

(71) Applicant: ALPINA PRODUCTOS ALIMENTICIOS S.A. BIC, SOPO (CO)

(72) Inventors: Bernadette Francisca KLOTZ CEBERIO, Bogotá (CO); David ORREGO LÓPEZ, Chía (CO)

(21) Appl. No.: 18/258,145

(22) PCT Filed: Dec. 16, 2021
(86) PCT No.: PCT/IB2021/061879

§ 371 Date: Jun. 16, 2023

(30) Foreign Application Priority Data
Dec. 17, 2020 (CO) NC2020/0015908
Dec. 15, 2021 (CO) NC2021/0017272

(51) Int. Cl. A23L 29/231; A23L 33/105; A23L 33/21; A23L 33/125

(52) U.S. Cl. CPC A23L 29/231; A23L 33/105; A23L 33/21; A23L 33/125

(57) ABSTRACT

A prebiotic carbohydrate composition is described comprising POS and galacturonic acid from fruit peel that can be used as an ingredient for the formulation of food products. The prebiotic carbohydrate composition is useful as a replacement for conventional sugars, maintaining the rheological characteristics of the product (texturizer) without increasing its caloric content. Moreover, the carbohydrate composition has bioactive potential, antioxidant capacity, and prebiotic properties.

### FIELD OF THE INVENTION

The composition of the present invention is related to the food and pharmaceutical industry, particularly with prebiotic pectinoligosaccharides and non-caloric sugar compositions.

### BACKGROUND OF THE INVENTION

Fruit processing to obtain food products and ingredients generates a large number of residues, since between 30 and 50% of fruit weight is not considered edible. These residues, despite being rich in a variety of molecules of high interest to the food, cosmetic and pharmaceutical industries, are often discarded as waste.

A field of interest for utilization of these agro-industrial residues consists in their recovery by the production of prebiotic compounds and non-caloric sugars. The best known commercially available prebiotics are indigestible oligosaccharides such as inulin, fructooligosaccharides (FOS), galacto-oligosaccharides, and lactulose. However, there is growing interest in identification and development of new prebiotic compounds with additional functions. Non-caloric sugars, such as galacturonic acid, mannose, rhamnose, arabinose, among others, allow for increasing the concentration of soluble solids in food products without increasing their caloric load and avoiding the addition of caloric sugars such as sucrose, fructose, and glucose. Moreover, some of these sugars can fulfill prebiotic functions.

Probiotic microorganisms are responsible for consuming prebiotics and proliferating in the human intestine, generating short-chain fatty acids with multiple benefits, and competing and inhibiting the growth of pathogenic microorganisms that cause health problems (Gullon et al., 2013). The following are some genera of microorganisms recognized as probiotics: Lactobacillus, Bifidobacterium, Saccharomyces, Enterococcus, Streptococcus, Bacillus, and Escherichia.

Pectin-derived oligosaccharides (POS) have been tested as possible prebiotic compounds, finding a protective effect on colonocytes against verocytotoxins of E. coli and stimulating apoptosis of colon adenocarcinoma cells. Moreover, the benefits of POS derived from orange processing have been demonstrated by stimulating the growth of bifidobacteria and E. rectale. These pectin-derived compounds can be formed with the use of pectinolytic enzymes on substrates such as tropical fruit albedo. For example, chemical methods such as acid (chemical) hydrolysis are commonly used for pectin extraction. However, the low specificity of reaction leads to unwanted compounds, lowering the extraction yield.

Among the information available, U.S. Pat. No. 8,313,789 addresses a method for promoting the growth of beneficial bacteria in the human intestine, wherein a composition comprising an effective amount of a pectinoligosaccharide moiety, containing Ara-(1-5)-(Ara)n-(1-5)-Ara, wherein n=0-18 and an arabinose to lactose ratio of 5.7 to 14.2, is administered. According to the examples, arabinose is in an amount between 20 and 45% mol and galacturonic acid is between 1 and 50% mol.

Moreover, US20090305362 relates to a chemical-mechanical process for the manufacture of uronic acid oligosaccharides based on the extrusion of pectin with an enzyme at basic pH conditions and the nutritional composition obtained therefrom. The nutritional composition comprises pectinoligosaccharide between 25 and 100% wt with a DP between 2 and 250, which are preferably not digestible by the human upper intestinal tract.

Finally, K. Klingchongkon et al. (2015) describe an oligosaccharide extraction process from passion fruit peel (PFP) powder by means of a subcritical water treatment that hydrolyzes pectin at temperatures between 100 and 245° C., wherein the oligosaccharides obtained can be useful as dietary fiber. The hydrolyzate obtained has galacturonic acid between 0.04 and 0.09 g/100 g of PFP and arabinose between 0.06 and 0.15 g/100 g of PFP.

Although the available documents describe methods and compositions containing pectinoligosaccharides from agro-industrial residues, it is necessary to design alternative compositions with a higher nutritional value for their incorporation into products with functional characteristics such as prebiotic activity, antioxidant capacity, and reduced calories, without leaving aside the technical and economic viability of their scaling.

### BRIEF DESCRIPTION OF THE INVENTION

In a first aspect, the invention is directed to a prebiotic carbohydrate composition obtained from a plant material comprising pectinoligosaccharides (POS), indigestible monosaccharides such as arabinose, mannose, rhamnose and galacturonic acid, and pectin. The prebiotic composition obtained allows for incorporating the benefits of prebiotic fibers resulting from the enzymatic hydrolysis of pectin in fruit peel, with benefits such as high antioxidant capacity, resulting in a set of soluble solids with low caloric content and potential prebiotic activity, which can be used as a texturizer in human food products.

In a second aspect, the invention is aimed at the use of the prebiotic carbohydrate composition as a texturizer, prebiotic supplement, antioxidant, and/or glycemic index reducer.

### BRIEF DESCRIPTION OF THE DRAWINGS

FIG. 1 Content of galacturonic acid in passion fruit and orange peel. Letters a, b, c, and d indicate a significant statistical difference between measurements, with an α of 0.05.

FIG. 2 Quantity of POS produced by enzymatic hydrolysis of passion fruit and orange peel. Letters a, b, c, and d indicate significant statistical difference between the measurements.

FIG. 3 Short-chain fatty acid (SCFA) profiles such as acetic acid, butyric acid, formic acid, lactic acid, propionic acid, and succinic acid at 20 h of microcolon fermentation.

FIG. 4 Process diagram of Example 12, wherein 1 is a mill, 2 is a bioreactor (enzyme hydrolysis/inactivation), 3 is a filter, 4 is an evaporator, and 5 is a pulverizer.

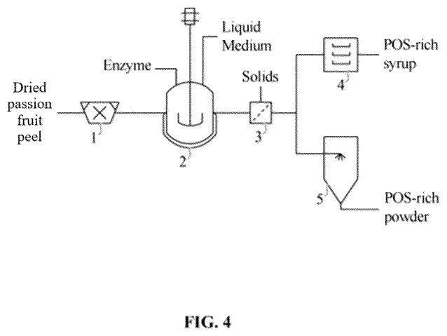

### DETAILED DESCRIPTION OF THE INVENTION

Prebiotic Carbohydrate Composition

The prebiotic carbohydrate composition described below is rich in prebiotics. Prebiotics are molecules that are resistant to digestion in the gastrointestinal tract and capable of modulating growth of their own beneficial microorganisms (probiotics), repressing the proliferation of less desirable bacteria. In particular, the prebiotic carbohydrate composition is mainly composed of pectinoligosaccharides (POS), indigestible monosaccharides, pectin, and digestible carbohydrates. Moreover, the composition could comprise organic acids typical of fruit, lignin, hemicellulose, cellulose, and antioxidants.

The prebiotic carbohydrate composition can be obtained from different plant materials, among which are passion flowers, citrus fruits, tubers, or a combination thereof. These plant materials have in common that they are characterized by their pectin content in some part of their body (e.g., in the peel or pulp) or in their whole body. In a preferred embodiment, the part of interest of the plant material is the peel. Preferably, the plant material has more than 10% pectin, or between 10 and 20% pectin. In an embodiment, the plant material is Passiflora spp., citrus, or tubers. Passionflowers include those of the subgenus Passiflora, particularly from the series Passiflora edulis f. edulis Sims and Passiflora ligularis, such as passion fruit, gulupa, curuba, granadilla, and badea. Plant material may also be selected from orange, lemon, tangerine, lime, grapefruit, citron, apple, onion, and sugar beet.

Then, the plant material is prepared before placing it in contact with the enzyme. The preparation of the plant material does not involve a chemical treatment. In said preparation, a decrease in moisture and/or a decrease in particle size is performed. In particular, moisture reduction is performed by any method known by a person of ordinary skill in the art, e.g., by drying for the necessary time until reaching a moisture between 4 and 8%, or less than 6%. The particle size is decreased until the plant material is between 0.1 and 1 mm in size, or less than or equal to 1 mm, or until a powder-like crushed plant material is obtained. For the purposes of this invention, pectin is obtained directly from the peel, i.e., pectin is not purified in peel by other means such as acid hydrolysis and ethanol precipitation, or enzymatic hydrolysis and ethanol precipitation. The fact that pectin is not purified allows for antioxidants and other useful carbohydrates to be preserved as bioactive compounds found in cellulose, hemicellulose, and lignin.

For the purposes of this invention, it is understood that pectinoligosaccharides or POS are understood to be oligosaccharides derived from pectin with degrees of polymerization (DP) between 2 and 15 or between 2 and 10. The pectinoligosaccharides (POS) are found in the composition between 1 and 80% w/w, between 10 and 70% w/w, between 10 and 50% w/w, between 20 and 60% w/w, between 25 and 50% w/w, between 30 and 45% w/w or between 25 and 35% w/w on a dry basis (bs), wherein dry basis is understood to be the composition of the solid material in the mixture excluding all water. In an embodiment, POS are found in the carbohydrate composition in an amount between 10 and 50%, wherein said POS are characterized by being mostly DP3, i.e., a value greater than 50%, greater than 70%, greater 80%, between 50 and 95%, between 65 and 85%, or between 70 and 95%.

As for indigestible monosaccharides, these correspond to monomeric sugars that cannot be metabolized in the human gastrointestinal tract. The non-digestible monosaccharides are selected from the group comprising arabinose, mannose, rhamnose, galacturonic acid, or a mixture thereof. Indigestible monosaccharides are found in the composition between 1 and 30% w/w, between 1 and 50%, or between 1 and 60.

In particular, the prebiotic carbohydrate composition is defined by its galacturonic acid content, while this indigestible monosaccharide is reported to be related to Elkeurti Khadidja et al. (2016), In vitro fermentation and bifidogenic potential of galacturonic acid. Galacturonic acid is found in the composition on a dry basis between 1 and 50% w/w, between 1 and 30% w/w, between 1 and 25% w/w, between 5 and 25%, between 5 and 20%, or between 1 and 15% p/p. In another embodiment, the monosaccharides are between 1 and 10% w/w arabinose; galacturonic acid between 1 and 5% w/w; rhamnose between 0 and 3% w/w; and mannose between 0.5 and 3% w/w.

Moreover, the prebiotic carbohydrate composition may contain pectin or trace amounts of pectin. Pectin is a type of branched heteropolysaccharide that is the main component of the middle layer of the cell wall and is 30% the dry weight of the primary cell wall in plant cells. Pectin is in the composition in an amount between 0 and 20% w/w, between 1 and 15% w/w, between 1 and 10% w/w, between 1 and 5% w/w, between 0 and 5% w/w, between 0 and 3% w/w, or between 0 and 1% w/w.

Optionally, the prebiotic carbohydrate composition also comprises digestible carbohydrates or carbohydrates with sweetening capacity. Digestible carbohydrates correspond to the group of poly, oligo, and monosaccharides that can be hydrolyzed and/or absorbed in the human gastrointestinal tract with caloric intake, galactose, glucose, fructose, and sucrose. Digestible carbohydrates can be found in the composition on a dry basis between 1 and 60% w/w, between 20 and 50% w/w, between 1 and 25% w/w, between 3 and 15% w/w, or between 0 and 10% w/w.

In an embodiment, the prebiotic carbohydrate composition comprises POS between 10 and 60% w/w; pectin between 0 and 15% w/w; and, as non-digestible monosaccharide, at least galacturonic acid between 1 and 25% w/w.

In an embodiment, the prebiotic carbohydrate composition comprises POS between 30 and 45% w/w; pectin between 0 and 15% w/w; and as non-digestible monosaccharide, at least galacturonic acid between 1 and 20% or between 1 and 25% w/w.

In another embodiment, the prebiotic carbohydrate composition comprises POS between 30 and 40% w/w; pectin between 0 and 5% w/w; and the non-digestible monosaccharides are galacturonic acid between 1 and 15% w/w; wherein DP3 content in the POS is between 65 and 85% w/w.

The prebiotic carbohydrate composition can be a liquid or a powder. The composition can be converted to a syrup if the concentration of soluble solids is increased by any method known to a person of ordinary skill in the art. The concentration of soluble solids in the composition can be modified according to the need for the product by any method known to a person of ordinary skill in the art. The composition has an acidic pH, e.g., between 3.5 and 5.

The prebiotic carbohydrate composition has bioactive potential. The prebiotic carbohydrate composition has antioxidant capacity, wherein the composition has a total phenol content between 1 and 15 mg of gallic acid (GAE) equivalent per g of dry matter, between 6 and 10 mg GAE/g db, or between 6.2 and 7.7 mg GAE/g db. The carbohydrate composition has a caloric load content between 1 and 3 kcal/g, between 1 and 2.5 kcal/g or between 1.5 and 2 kcal/g. The composition is characterized in that the glycemic index is less than 55.

The prebiotic carbohydrate composition also includes ash between 30 and 45%, protein between 2 and 15%, fat between 0 and 1%, or between 0 and 0.02%, identified carbohydrates (POS, non-caloric and caloric sugars derived from pectin) between 35 and 70%, and unidentified carbohydrates between 1 and 50%. Moreover, it may comprise antioxidant compounds, among other components.

Production Method

The prebiotic carbohydrate composition is performed, e.g., by enzymatic hydrolysis of plant material and enzymes with pectinase, cellulase, hemicellulase activity, or combinations thereof, among others. In a preferred embodiment, the enzyme has more than one pectinase, cellulase, and hemicellulase activity, which synergistically allows for more efficient access to pectin in this type of plant matrices, which can be more complex since pectin is not isolated.

Peels of plant material with an average moisture between 1 and 90% are used, or preferably dry peels between 1 and 10%, or between 2 and 5%. The peels are crushed to reduce their particle size, preferably until reaching a particle size between 1 and 5 cm, less than 2 cm, 10 mm, less than 5 mm, less than or equal to 1 mm, or between 0.2 and 0.7 mm.

Optionally, a bleaching step can be performed, wherein digestible sugars such as glucose are eliminated. Said bleaching consists of subjecting the peel to high temperatures, e.g., placing the plant material in hot water at temperatures between 70 and 95° C. for as long as necessary to eliminate some of the caloric sugars (such as glucose and fructose) in the peel, and inactivate endogenous enzymes that may affect the POS production process. Then, the peels are drained.

Regardless of whether or not the bleaching step is performed, the particles are then suspended in an aqueous medium, e.g., medium that can be water with pH adjustment or a buffer substance such as citrate (at a solid concentration between 3 and 10% w/w, between 4 and 7% w/w), phosphate, or any other known by a person of ordinary skill in the art. The enzyme is added and allowed to hydrolyze. The enzyme is inactivated by increasing the temperature to between 80 and 100° C., up to between 85 and 95° C. for the time necessary to completely inactivate the enzyme. Insoluble solids are separated by means of a solid-liquid separation, e.g., by centrifugation, filtration, and/or decantation. Enzyme inactivation can be performed before or after the separation of insoluble solids.

The resulting solution presents pectin oligosaccharides (POS) and galacturonic acid, as well as other possible carbohydrates such as pectin, glucose, arabinose, mannose, rhamnose, and galactose, among others.

Uses

The proposed product corresponds to a prebiotic carbohydrate composition that comprises POS and non-caloric and caloric sugars derived from pectin, which can be used as an ingredient for the formulation of food products. The composition is useful as a texturizer, prebiotic supplement, antioxidant, and/or glycemic index reducer.

The prebiotic carbohydrate composition is a mixture of pectinoligosaccharides (POS) and non-caloric monosaccharides such as galacturonic acid, as well as mannose, rhamnose, arabinose, among others, which can be used as a replacement for caloric soluble solids in food products. Its non-caloric monosaccharide content allows for the product rheological characteristics to be maintained without increasing its caloric content. Furthermore, in an embodiment, the composition of the invention can be used as an added sugar replacement.

### EXAMPLES

### Example 1. Preparation of Passion Fruit and Orange Peels

Peels of orange and passion fruit were obtained from household residues and stored frozen at −20° C. until use.

Once thawed, peels were cut to reduce their size and facilitate drying in a convection oven at 55° C. for 72 h, until reaching a moisture between 4 and 6%. After drying, the dried peels were brought to room temperature in a dissector and were crushed in a blender to a particle size less than or equal to 1 mm. The resulting powdered peel was stored in a sealed bag at room temperature.

### Example 2. Preliminary Hydrolysis Test with Commercial Enzymes in Terms of Viscosity

An enzymatic hydrolysis test of passion fruit peel (powdered, resulting from Example 1) was performed using three commercial enzymes, i.e., EnzA, EnzB, and EnzC, characterized by having pectinase, cellulase, and hemicellulase activity.

Then, 100 mL of a powdered peel suspension from Example 1 was prepared in 50 mM citrate buffer with a 4% w/v peel concentration. Then, 1% v/v of EnzA, EnzB, or EnzC enzyme diluted to a protein concentration of 10 mg/mL was added. Hydrolysis was performed in spinner flasks at 150 rpm and 40° C. for 2 hours. Duplicate hydrolysis was performed for each enzyme. A powdered peel solution from Example 1 was included as a control, to which no enzyme was added. After hydrolysis, 5 mL samples were taken in test tubes and placed in water baths with boiling water for 10 min to inactivate the enzyme.

Then, the hydrolyzates were centrifuged at 4500 rpm for 5 min to remove large solids. The supernatant was used for viscosity measurements in a Discovery HR-1® rheometer. A cone and plate configuration with a shear rate of 100 s⁻¹ at 30° C. was used for viscosity measurements. The viscosity values reported in Table 1 correspond to the average of measurements taken in a period of 20 min.

TABLE 1
Viscosity of peel powder solutions after 2 h of
hydrolysis with commercial enzymes

| | Average | Standard | Viscosity |
|---|---|---|---|
| Enzyme | Viscosity (Pa · s) | Deviation | Reduction (%) |
| Control | 6.7E−03 | 1.8E−04 | — |
| EnzB | 2.8E−03 | 1.2E−04 | 58.0 |
| EnzA | 2.9E−03 | 8.7E−05 | 57.5 |
| EnzC | 2.5E−03 | 1.9E−04 | 62.8 |

Among the enzymes tested, EnzC resulted in the highest viscosity reduction of the peel solution (Table 1) compared to the values obtained with EnzA and EnzB, which were slightly higher and very similar to each other.

### Example 3. Evaluation of Pectin Hydrolysis Capacity in Terms of Loose Galacturonic Acid for Passion Fruit and Orange Peel, Catalyzed by Pectinase Enzymes

The hydrolysis capacity of enzymes EnzC, EnzA, EnzB and the combination of an enzyme with Endopolygalacturonase activity (EnzC) and another with pectin-esterase activity (EnzD) was tested to examine the effect on pectin hydrolysis by reducing the esterification degree thereof. Enzymatic hydrolysis has proven to be more efficient and precise than total hydrolysis with dilute acids whose hydrolysis reactions are more non-specific and lead to undesired degradation of sugar monomers, altering the result.

A unifactorial design was used where each enzyme was a level, and the response variable was the concentration of galacturonic acid (AGA) at the end of the process. The Tukey test (α=0.05) was performed to compare the means of the different treatments and determine the enzyme capable of hydrolyzing the greatest amount of pectin in passion fruit and orange peels. For this purpose, the IBM SPSS Statistics Base® software, version 22 (IBM, USA) was used. Enzymes with the highest hydrolysis capacity were used in the tests to produce the prebiotic composition.

The hydrolysis was performed with 4% w/v powder solutions from Example 1 in 50 mM citrate buffer, pH 5. The enzyme concentration was 5% (v/v), at an initial protein concentration of 10 mg/mL, except for EnzD, which was added at 1% (v/v). The hydrolysis was performed in a flask with a volume of 50 mL, in an orbital shaker at 150 rpm and 50° C., for 24 hours. All treatments were performed in duplicate. A control was included for each powdered peel solution under the same process conditions but without enzyme addition.

At the end of the hydrolysis, 10 mL of solution were recovered, which were centrifuged at 4500 rpm for 5 min to remove the solids. The supernatant was stored at −15° C. until use.

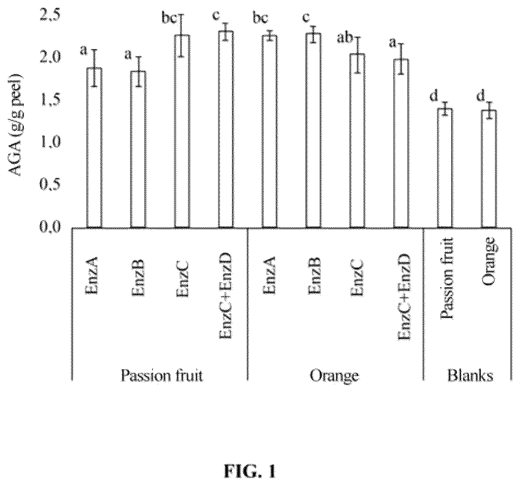

AGA was measured in the hydrolyzed samples by high performance liquid chromatography (HPLC) with a Flexar® equipment (Perkin Elmer, USA), using a C18 Acclaim Polar Advantage II® column (Thermo Fisher Scientific, USA) (120 Å, 150×4.6 mm, 5 μm p.s.) and a UV-Vis detector at 201 and 230 nm. A gradient of phosphate buffer, pH 7.4 (solvent A) and acetonitrile (solvent B) was used as follows: 0-2 min, 100% solvent A; 2-10 min, 20% solvent A, 10-14 min, 100% solvent A, ending with 10 min reequilibration (100% solvent A). The flow was 1 mL/min and the temperature was 60° C., with an injection volume of 10 μL. Each sample was injected 6 times. The calibration curve was performed with a galacturonic acid monohydrate standard (Sigma Aldrich, Ref. 48280-5G-F, purity ≥97%). FIG. 1 shows the results of galacturonic acid obtained from the enzymatic hydrolysis of passion fruit and orange peel.

From the results obtained, it can be concluded that enzyme action had a significant effect on pectin hydrolysis of both peels, given the higher concentration of AGA found in these treatments, compared to the blanks where no enzyme was added. For passion fruit, the EnzC enzyme and the EnzC+EnzD combination have the highest hydrolysis capacity, compared to the EnzA and EnzB enzymes, while for orange, the EnzA and EnzB enzymes have the highest efficiency in pectin hydrolysis. Comparing AGA concentrations between both substrates, it is found that there is no significant difference for the treatments with higher hydrolysis efficiency, which allows us to infer that the pectin concentration between both peels is similar.

Based on the results previously obtained, the experimental work on the production of a composition rich in prebiotics with the EnzC and EnzA enzymes for the hydrolysis of passion fruit and orange peels, respectively, continued.

### Example 4. Optimization of Hydrolysis Conditions to Produce POS from Passion Fruit And Orange Peels

In order to test the production of POS from passion fruit and orange peel, a complete factorial design was performed with two factors and two levels (2²), as shown in Table 2. All hydrolyses with passion fruit peel were performed with the commercial EnzC enzyme and hydrolyses with orange peel were performed with the commercial EnzA preparation.

TABLE 2
Experimental design for optimization of time and
enzyme concentration in the production of
pectinoligosaccharides

| | | | Enzyme | |
|---|---|---|---|---|
| | Treatment | | Conc. | Hydrolysis |
| Peel | # | Enzyme | (% v/v) | time (h) |
| Passion fruit | 1 | EnzC | 0.5 | 0.5 |
| | 2 | | 2 | 0.5 |
| | 3 | | 0.5 | 2 |
| | 4 | | 2 | 2 |
| Orange | 5 | EnzA | 0.5 | 0.5 |
| | 6 | | 2 | 0.5 |
| | 7 | | 0.5 | 2 |
| | 8 | | 2 | 2 |

All tests were performed in duplicate with 4% w/v solutions of powdered peel from Example 1 in 50 mM citrate buffer, pH 5. Hydrolysis was performed in a spinner flask with a working volume of 50 mL, in an orbital shaker at 150 rpm at 50° C. At the end of the hydrolysis, 10 mL of solution were recovered, and the enzyme was inactivated by placing the samples in a boiling water bath for 10 min. Then, they were centrifuged at 4500 rpm for 5 min to remove solids and the supernatant was stored at −15° C. until use.

The POS content in the samples obtained from the experimental design was quantified using high performance liquid chromatography (HPLC) coupled to an ELSD detector. A Hypercarb® 100×4.6 mm column (Thermo Scientific) was used at a temperature of 60° C., flow rate of 0.8 mL/min using an elution gradient with 0.01% trifluoroacetic acid (TFA) and acetonitrile. Standards of galacturonic acid monomers, dimers, and trimers were used for the quantification of POS in the samples and the distribution of the degrees of polymerization.

The POS yield per gram of peel (dry weight), i.e., the amount of peel converted into POS, was used as variable of response. Moreover, the degrees of polymerization and total concentration of pectin-derived monomers were determined. Variance analysis and comparison of means were performed with the Duncan test and a of 0.05.

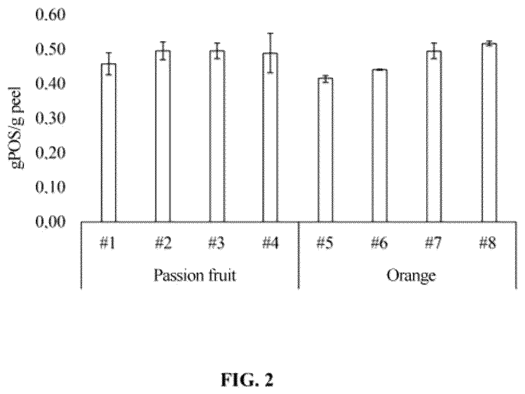

FIG. 2 shows POS production yields, expressed as g POS/g peel (dry basis), for the enzymatic hydrolysis performed with passion fruit and orange peels.

As shown in FIG. 2, there was no difference in the production of POS between any of the treatments performed, except for treatments 5 and 8, for orange peel. This implies that it was possible to fraction the pectin at low enzyme concentrations (0.5% v/v) and short process times (30 min), obtaining an approximate POS yield of 0.5 g/g, both in passion fruit and orange peel.

In the study performed by Gomez et al. (2016) to produce pectin-oligosaccharides (POS) from lemon peels, by three different methods (extraction with water, enzymatic hydrolysis, and membrane filtration), yields of 0.45 to 0.55 g/g were found. On the other hand, in the work performed by Martinez et al. (2012) for the generation of POS from orange residues by enzymatic hydrolysis, yields of 0.31 g/g were reached. In the study to produce oligosaccharides from passion fruit peel by treatment with subcritical water, yields of 0.21 g/g were achieved (Klinchongkon, Khuwijitjaru, Wiboonsirikul, & Adachi, 2017). The studies previously reported include pretreatment of raw material prior to the process to produce oligosaccharides, either through pectin purification or removal of soluble compounds. These additional treatments would entail costs when taking the process to an industrial level, which may affect the techno-economic viability of the process.

In the methodology proposed in this study, not only are POS yields similar to or higher than those reported in the literature obtained, but a simple process of enzymatic hydrolysis is proposed where the only pretreatment of raw material consists of drying and reducing the particle size. This represents a technical advantage that will positively affect the economic evaluation of the process and will allow continuing the evaluation of technology on a larger scale.

### Example 5. Carbohydrate Compositions Obtained from Passion Fruit Peel

Following the process described in the previous examples and using passion fruit peel as starting plant material, carbohydrate compositions No. 1 to 8 were obtained as described in Table 3:

TABLE 3
Prebiotic carbohydrate composition from passion fruit peel
(% w/w, dry basis)

| | Galacturonic | | | | | |
|---|---|---|---|---|---|---|
| | Acid | POS | Sucrose | Glucose | Galactose | Fructose |
| | (% db) | (% db) | (% db) | (% db) | (% db) | (% db) |
| 1 | 1.9 | 30 | 1.1 | 1.2 | 0.1 | 2.1 |
| 2 | 1.8 | 33 | 1.0 | 1.3 | 0.1 | 2.5 |
| 3 | 4.3 | 33 | 1.5 | 2.1 | 0.2 | 2.1 |
| 4 | 4.2 | 31 | 0.8 | 1.0 | 0.1 | 1.3 |
| 5 | 4.5 | 32 | 0.6 | 1.1 | 0.1 | 1.6 |
| 6 | 4.2 | 31 | 0.5 | 1.3 | 0.1 | 1.2 |
| 7 | 6 | 32 | 0.8 | 3.4 | 0.2 | 2.1 |
| 8 | 4 | 29 | 2.6 | 6.9 | 0.4 | 5.4 |

The resulting composition has pectinoligosaccharide content with prebiotic properties, according to what has been reported in the scientific literature. Moreover, the content of non-digestible carbohydrates (POS, galacturonic acid) allows for increasing the concentration of solids in formulas without increasing the caloric load thereof. The content of sucrose, glucose, fructose, and galactose of natural origin enables the replacement of refined sugar in food products to avoid declaring the ingredient as “added sugar.”

TABLE 4
Degrees of POS polymerization obtained from prebiotic
carbohydrate composition from passion fruit peel
(Participation in percentage, by degree of polymerization)

| Composition No. | DP2 | DP3 | >DP3 |
|---|---|---|---|
| 1 | 1.65 | 90.73 | 0.97 |
| 2 | 1.56 | 91.68 | 1.04 |
| 3 | 1.24 | 85 | 0.87 |
| 4 | 1.16 | 84.5 | 1 |
| 5 | 1 | 85.12 | 0.89 |
| 6 | 1.09 | 85.11 | 0.87 |
| 7 | 1.04 | 81.36 | 0.44 |
| 8 | 2.44 | 84.45 | 0.42 |

The high content of oligosaccharides with degree of polymerization 3 represents a functional advantage of the product since it has been shown that POS with degrees of polymerization between 2-6 promote the selective growth of probiotic bacteria such as bifidobacteria, even above oligosaccharides with higher degrees of polymerization (Al-Tamimi et al., 2006; Holck et al., 2011). Moreover, pectin-derived oligosaccharides, including short-chain ones, have been found to have the ability to reduce adhesion of pathogenic bacteria such as L. monocytogenes, E. coli, and S. typhimurium to human intestinal walls (Wilkowska et al., 2019).

### Example 6. Bench-Scale Test (2 L) of Passion Fruit Peel Hydrolysis to Produce Prebiotic Carbohydrate Composition Brought to 68° Brix Syrup

Passion fruit peels were prepared through two different treatments: Drying and crushing, and hydrothermodynamic cavitation. In the first treatment, peels were manually cut and placed in a convective oven at 55° C. for 48 hours, until reaching an average moisture of 5%. Then, they were crushed in a kitchen blender and the resulting powder was passed through a 1 mm sieve. Finally, the peel powder was stored in a sealable bag at 4° C. In the second treatment, a mixture of water:peel in a 45:55 ratio was passed through hydrothermodynamic cavitation equipment (Kavitec, Colombia), wherein the mixture temperature was brought to 45° C. before stopping the process. The peel suspension in water was stored in sealable bags at −20° C.

In order to evaluate the effect of cavitation pretreatment or convection drying performed on passion fruit peel on the enzymatic production of POS, the treated peels described above were used as raw materials. In both cases, the peel suspensions were at a concentration of 6.6% w/w in 50 mM citrate buffer, pH 5. An EnzC enzyme was used at a concentration of 1.32 mg protein/g peel. Moreover, a negative control was included, which was obtained from the cavitation process, without enzyme addition.

The reactions were performed in 2-L stirred-tank reactors with a working volume of 1 L. The medium was stirred at 450 rpm and kept at a temperature of 50° C. for 1 hour. At the end of the reaction time, large solids were removed with a 1 mm sieve and 600 mL of medium were recovered, which were placed in a boiling water bath to inactivate the enzyme. Then, the medium was centrifuged at 4500 rpm for 10 min in order to remove small solids and obtain a translucent solution. This solution was taken to rotaevaporation, seeking to reduce the water content in the sample and facilitate analytical techniques for the quantification of POS and other carbohydrates. Samples were stored frozen until use.

For the determination of oligosaccharides and galacturonic acid, HPLC was used coupled to an ELSD detector with a Hypercarb 100×4.6 mm 5 μm column (Thermo Scientific) at a temperature of 60° C., a flow of 0.8 mL/min, using two eluent types: 0.01% trifluoroacetic acid and acetonitrile. Galacturonic acid, digalacturonic acid, and trigalacturonic acid were used as standards, wherein all peaks between galacturonic and digalacturonic acid were added as POS DP2, all peaks between digalacturonic and trigalacturonic acid were added as POS DP3 and, finally, all peaks above trigalacturonic acid were added as POS>DP3.

TABLE 5
Syrup POS composition (68° Brix)

| | | g/L | % db |
|---|---|---|---|
| Cavitation | Galacturonic acid | 89.23 | 9.8 |
| | POS | 259.49 | 28.5 |
| Drying | Galacturonic acid | 95.65 | 10.5 |
| | POS | 314.00 | 34.5 |
| Control | Galacturonic acid | 31.30 | 3.4 |
| | POS | 60.22 | 6.6 |

A total of POS between 301.8 and 404.4 g/L was obtained, on average with a DP2 of 1.0, DP3 of 72% and >DP3 of 0.5.

The caloric content contributed by the carbohydrate component of the syrup composition described above for the dried and crushed treatment was evaluated, assuming the following caloric load:

TABLE 6
Caloric load components

| | Calories (Kcal/g) |
|---|---|
| Galacturonic acid | 4 |
| POS | 1.5 |

Said syrup composition obtained has a total caloric content of 0.94 kcal/g on average, assuming these two components; meanwhile, if a contribution with additional components such as other carbohydrates and protein is assumed, it has a caloric content between 1.5 and 2 kcal/g. Compared with a conventional sucrose syrup that has a caloric load of 4 kcal/g, a caloric reduction equal to or greater than 50% is obtained.

### Example 7. POS Production Kinetics in a 10-L Reactor

The enzymatic reaction to produce POS was performed from passion fruit peel dried in a convective oven and crushed to a particle size less than or equal to 1 mm. The peel was diluted in 50 mM pH 5 citrate buffer to a concentration of 7% w/w.

The enzymatic reaction was performed in a 10-L reactor using 5 L as working volume and an EnzC enzyme. The reaction was performed at 50° C. and a stirring speed of 500 rpm. The enzyme concentration was 1.32 g protein/g peel. Samples of the medium were taken at 0.5, 1, and 1.5 hours of the process and solids were removed, and the enzyme was inactivated.

Each sample was stored frozen prior to analysis of POS and sugars present in pectin such as galacturonic acid.

TABLE 7
Galacturonic acid and POS content at different reaction times

| | Component | g/L | % db |
|---|---|---|---|
| 0.5 h | Galacturonic acid | 110.39 | 12.1 |
| | POS | 353.73 | 38.9 |
| 1 h | Galacturonic acid | 133.60 | 14.7 |
| | POS | 376.31 | 41.4 |
| 1.5 h | Galacturonic acid | 136.09 | 15.0 |
| | POS | 335.62 | 36.9 |

An amount of POS between 335.6 and 376.3 g/L was obtained, on average with a DP2 of 0.53, DP3 of 71% and >DP3 1.1.

### Example 8. Measurement of the Antioxidant Capacity of the Prebiotic Composition of Carbohydrate Syrups

The antioxidant capacity of the syrup composition rich in POS obtained in Example 6 was measured at different concentrations of soluble solids, measured as Brix degrees (g soluble solids/100 g of syrup). The DPPH technique was used, as described by Brand-Williams, Cuvelier, & Berset (1995) and the result is expressed as a percentage of inhibition:

TABLE 8

| ° Brix | Inhibition % |
|---|---|
| 23.7 | 84 |
| 21.3 | 83 |
| 17.3 | 71.5 |
| 15.6 | 69.9 |
| 11.6 | 67.9 |
| 4 | 30.1 |

As observed in the results, the syrup composition has antioxidant activity at different concentrations of soluble solids, with considerable activity even at low values of soluble solids such as 4 g/100 g solution. With higher Brix degrees, the greater its antioxidant activity that can be transferred to the products wherein it is applied.

An analysis of total phenols was performed on the compositions according to Example 5 by the Folin-Ciocalteu technique, and the result was expressed in GAE (gallic acid equivalent) on a dry basis (DB), wherein the following results were obtained:

TABLE 9

| Type | mg GAE/g DB |
|---|---|
| Bleached | 6.2-7.2 |
| Unbleached | 6.7-7.7 |

When comparing these results with those disclosed in the prior art, e.g., the one reported by Macagnan et al., (2015), wherein the total phenols of powdered passion fruit peel were quantified with the Folin-Ciocalteu technique, finding a concentration of 6.9 mg GAE/g DB, the bioactive potential in the prepared syrup composition is demonstrated.

### Example 9. Incorporation of the Prebiotic Carbohydrate Composition as a Texturizer in Beverages

The POS syrup obtained according to Example 6 was added to two blackberry-based and pear-based drink-type products at a concentration of 2.25%. Viscosity was measured both in the standard and the test, and the following results were obtained:

TABLE 10

| Product | Viscosity (cP) | Total Soluble Solids (Brix) |
|---|---|---|
| Blackberry drink | 201 | 6.1 |
| Blackberry drink + POS | 215 | 7.5 |
| Pear drink | 7.45 | 8 |
| Pear drink + POS | 7.8 | 9.3 |

It is shown that the addition of POS syrup to fruit drinks brings an increase in viscosity. However, according to the previous examples, this does not imply a caloric increase in the product.

### Example 10. Proximal Analysis of the Prebiotic Carbohydrate Syrup Composition

The protein, fat, and ash content of the syrup composition set forth in Example 6 was measured using the Dumas method, ether stripping, and gravimetry, respectively. The following results were obtained:

TABLE 11

| | Dry Basis % |
|---|---|
| Ash | 36.24 |
| Fat | 0.09 |
| Protein | 10.0 |
| Identified carbohydrates | 50.5 |
| Others | 3.2 |
| Total | 100 |

The identified carbohydrates correspond to POS, non-caloric and caloric sugars derived from pectin. In others, it is possible that there are other unidentified carbohydrates.

### Example 11. Prebiotic Activity Test of the Prebiotic Carbohydrate Composition

In order to test the prebiotic activity of the syrup rich in POS generated from the composition, MicroColon fermentation was performed using a mixture of fecal feces obtained from 6 healthy adults as a culture medium. The prebiotic activity was determined from the formation of short chain fatty acids (SCFA) which are known as indicators of the growth of probiotic microorganisms in the human gastrointestinal system. According to the article published by Markowiak-Kopec et al. (2020), the presence of SCFA in the human body, mainly acetic, butyric and propionic, in adequate amounts, is essential for consumer's health and wellness. However, the formation of these acids depends on the adequate intake of substrates, such as dietary fibers and prebiotics, necessary for the correct evolution of fermentations. The benefits attributed to SCFA are not only limited to the gastrointestinal health of humans, since links have also been found between the presence of these compounds with the proper functioning of the brain, avoiding conditions such as depression, Alzheimer's, Parkinson's, and autistic disorders (Silva et al., 2020).

In order to test the concentrations of organic acids in microcolon fermentations, which may be derived from production or consumption by microbial organisms, supernatants from microcolon fermentations were analyzed using a high-performance liquid chromatography (HPLC) method, which separates, identifies, and quantifies each component in a mixture.

Organic Acid Concentrations

The following organic acids have been identified and quantified in microcolon fermentation supernatants: acetic acid, butyric acid, formic acid, lactic acid, propionic acid, and succinic acid.

The total SCFA results after 20 h of fermentation are shown below:

TABLE 12

| Sample# | Condition |
|---|---|
| AL084 | Alpina POS 15 mg/mL |
| AL085 | Alpina POS 10 mg/mL |
| AL086 | Alpina POS 5 mg/mL |
| AL087 | Vivinal GOS 15 mg/mL |
| AL088 | Vivinal GOS 10 mg/mL |
| AL089 | Vivinal GOS 5 mg/mL |
| AL090 | FOS Orafti P95 15mg/mL |
| AL091 | FOS Orafti P95 10mg/mL |
| AL092 | FOS Orafti P95 5 mg/mL |
| AL105 | Alpha GOS PEA 15 mg/mL |
| AL106 | Alpha GOS PEA 10 mg/mL |
| AL107 | Alpha GOS PEA 5 mg/mL |
| AL137 | Water control |
| AL138 | Water control |

TABLE 13

| | Succinic | Lactic | Formic | Acetic | Propionic | Butyric | |
|---|---|---|---|---|---|---|---|
| | Acid | Acid | Acid | Acid | Acid | Acid | Σ |
| #Sample | (mg/L) | (mg/L) | (mg/L) | (mg/L) | (mg/L) | (mg/mL) | (mg/mL) |
| AL084 | 1504 | 4700 | 183 | 3982 | 219 | 284 | 10.9 |
| AL085 | 68 | 3710 | 191 | 3518 | 778 | 316 | 8.6 |
| AL086 | 19 | 2427 | 200 | 3223 | 646 | 380 | 6.9 |
| AL087 | 71 | 1757 | 90 | 1628 | 214 | 113 | 3.9 |
| AL088 | 100 | 3526 | 209 | 3279 | 430 | 241 | 7.8 |
| AL089 | 80 | 3317 | 212 | 3262 | 436 | 282 | 7.6 |
| AL090 | 103 | 3447 | 270 | 2782 | 431 | 271 | 7.3 |
| AL091 | 121 | 3434 | 269 | 2625 | 438 | 292 | 7.2 |
| AL092 | 82 | 3224 | 266 | 2732 | 410 | 297 | 7.0 |
| AL105 | 115 | 3329 | 245 | 3072 | N/A | 279 | 7.0 |
| AL106 | 135 | 3393 | 242 | 3118 | 460 | 294 | 7.6 |
| AL107 | 83 | 3188 | 240 | 3203 | 435 | 276 | 7.4 |
| AL137 | 21 | 1713 | 356 | 2676 | 418 | 546 | 5.7 |
| AL138 | 20 | 1656 | 332 | 2619 | 425 | 544 | 5.6 |

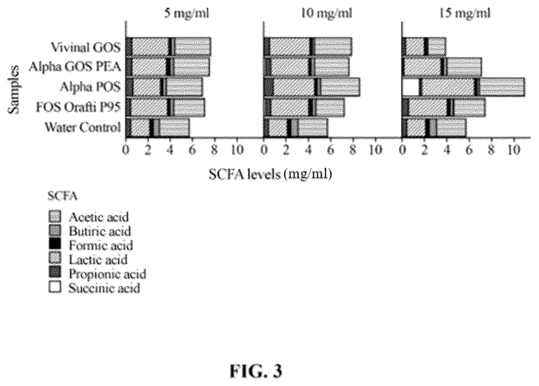

The information summarized above is also described in FIG. 3.

It is concluded that after 20 hours of fermentation, most of the tested components show an increase in total SCFA, wherein the strongest effects are caused by Alpina POS (all concentrations tested), wherein Alpina POS corresponds to the prebiotic carbohydrate composition claimed herein. Moreover, it is concluded that the main driver of the increase in SCFA is lactic acid. The strong increase of succinic acid in the conditions of Alpina POS 15 mg/mL is notable.

### Example 12. Pilot-Scale Test (40 L) of Passion Fruit Peel Hydrolysis to Produce a Prebiotic Carbohydrate Composition

The enzymatic hydrolysis of the passion fruit peel was performed in a 50-L stirred-tank reactor, with a working volume of 40 L. The passion fruit peel was subjected to the drying treatment mentioned in Example 1 until a powder with a particle size equal to or less than 1 mm. With this powder, a 7% w/w suspension of the shell was made in 50 mM sodium citrate buffer, pH 5. The suspension was brought to 50° C. in the stirred-tank reactor and the enzyme EnzC was added at a concentration of 1.32 mg protein/g of peel. The suspension was stirred for 50 min at 480 rpm. Once the enzymatic reaction time was over, the temperature in the reactor was increased to 80° C. for between 15 and 20 minutes, with the aim of inactivating the enzyme.

Since there is no technical information that indicates how the scaling process obtains POS in higher volumes (>10 kg of suspension), it was proposed to pass the suspension of solids through a filter press with five plates, a retention capacity between 0.1 and 0.5 kg/plate, a pore size of less than 1 μm, a filter area of 0.7 m², a liquid of the composition is obtained. This liquid was evaporated to concentrate the soluble solids until reaching 68-75° Brix, obtaining a syrup composition. A prebiotic carbohydrate composition is obtained with characteristics similar to those previously reported and characterized by the following monosaccharide content.

TABLE 14

| | Galacturonic | | | |
|---|---|---|---|---|
| | Acid | Glucose | Fructose | Arabinose |
| Filtered (% db) | 18-20 | 8-12 | 12-16 | 0.5-1.5 |

1. A prebiotic carbohydrate composition from a plant material comprising pectinoligosaccharides (POS) between 10 and 50% w/w db, and galacturonic acid between 1 and 30% w/w db,
wherein the plant material has no chemical pretreatment for the pectin purification,
wherein the carbohydrate composition has a total phenol content between 1 and 10 mg of gallic acid equivalent per grams of dry matter; and
wherein the composition has a caloric load content between 1 and 2.5 kcal/g.

2. The composition of claim 1, wherein the plant material is selected from among passion flowers, citrus fruits, tubers, or a combination thereof.

3. The composition of claim 1, further comprising carbohydrates with sweetening capacity such as glucose, fructose, galactose, and sucrose between 1 and 60% w/w.

4. The composition of claim 1, wherein the DP3 content in POS is between 65 and 85% w/w.

5. The composition of claim 1, wherein the total phenol content is between 6.2 and 7.7 mg GAE/g db and the caloric load is between 1.5 and 2 kcal/g.

6. The composition of claim 1, further comprising non-digestible monosaccharides selected from the group comprising between 1 and 30% arabinose, mannose, rhamnose, or a mixture thereof.

7. The composition of claim 1, comprising on a dry basis:
POS between 30 and 45% w/w;
galacturonic acid between 1 and 20% w/w; and
pectin between 0 and 15% w/w.
